(19) United States
(12) Patent Application Publication
(10) Pub. No.: US 2025/0229659 A1
(43) Pub. Date: Jul. 17, 2025

(54) ELECTRIC VEHICLE OVERHEAD CHARGING USING BIDIRECTIONAL POWER MULTI-DROP

(71) Applicant: Cisco Technology, Inc., San Jose, CA (US)

(72) Inventor: Joel Richard Goergen, Soulsbyville, CA (US)

(21) Appl. No.: 18/414,739

(22) Filed: Jan. 17, 2024

(51) Int. Cl. B60L 53/35; B60L 53/16; B60L 53/53; B60L 53/66; H02J 7/00

(52) U.S. Cl. CPC B60L 53/35; B60L 53/16; B60L 53/53; B60L 53/66; H02J 7/00045

(57) ABSTRACT

A system is provided for a multi-drop overhead charging of electric vehicles and fault managed power distribution. The system includes at least two overhead wires that extend over a predetermined distance and are configured to bidirectionally distribute power among one or more electric vehicles. The system further includes a mounting arrangement configured to support the at least two overhead wires at a predetermined level above ground and one or more connection interfaces. Each connection interface is configured to contact the at least two overhead wires and connect to a respective electric vehicle to charge a battery therein or to obtain the power from the battery and provide the power to the at least two overhead wires to charge another battery of another electric vehicle.

### TECHNICAL FIELD

The present disclosure relates to electric vehicle charging, power distribution, data management, and data communications.

### BACKGROUND

Electric vehicles (EV) are becoming more common. This means that the number of charging stations for the EVs will also increase significantly in the future. For the EVs to become prevalent, charging stations should be readily available in many locations such as shopping malls, entertainment centers, rest areas, and other parking places. To add a commercial charging station, a trench is dug up and a charging station is installed for a vehicle parking space. For multi-family parking areas such as a parking lot or a parking garage, digging up concrete pavement for power and adding charging stations is costly and time consuming. After the charging stations are installed, curbs and/or concrete are resurfaced and landscaping is restored, which further adds costs.

### BRIEF DESCRIPTION OF THE DRAWINGS

FIG. 1 is a view illustrating a system with overhead wires for power distribution, which span over multiple vehicle parking spaces, according to an example embodiment.

FIG. 2 is a diagram illustrating a system configured to provide fault managed power (FMP) to the overhead wires of FIG. 1, according to an example embodiment.

FIG. 3 is a diagram illustrating a system in which electric vehicles charge or discharge using connection interfaces that are connected to the overhead wires of FIG. 1, according to an example embodiment.

FIG. 4 is a diagram illustrating a retractable connector configured to connect to the overhead wires of FIG. 1 using a motorized mechanism, according to an example embodiment.

FIG. 5 is a diagram illustrating a system in which network communications are enabled for an electric vehicle using the overhead wires of FIG. 1, according to an example embodiment.

FIG. 6 is a diagram illustrating a multi-drop system in which network communications are enabled for an electric vehicle using a connection interface, according to an example embodiment.

FIG. 7 is a flow diagram illustrating the electric vehicle of FIG. 6 establishing a communication path with a network device, according to an example embodiment.

FIG. 8 is a block diagram illustrating a connection interface in which high speed data communication is enabled, according to another example embodiment.

FIG. 9 is a flowchart illustrating a method of bidirectionally distributing power among one or more electric vehicles via at least two overhead wires, according to an example embodiment.

FIG. 10 is a hardware block diagram of a computing device that may perform functions associated with any combination of operations in connection with the techniques depicted and described in FIGS. 1-9, according to various example embodiments.

### DESCRIPTION OF EXAMPLE EMBODIMENTS

### Overview

Briefly, systems, apparatuses, and methods are presented for a multi-drop overhead charging of electric vehicles and fault managed power distribution.

In one form, a system is provided. The system includes at least two overhead wires that extend over a predetermined distance and are configured to bidirectionally distribute power among one or more electric vehicles. The system further includes a mounting arrangement configured to support the at least two overhead wires at a predetermined level above ground and one or more connection interfaces. Each connection interface is configured to contact the at least two overhead wires and connect to a respective electric vehicle to charge a battery therein or to obtain the power from the battery and provide the power to the at least two overhead wires to charge another battery of another electric vehicle.

In another form, an apparatus is provided. The apparatus includes an electric charging interface configured to charge a battery of an electric vehicle when connected to the electric vehicle. The apparatus further includes a connector attached to the electric charging interface and configured to contact at least two overhead wires for a bidirectional power distribution with the battery of the electric vehicle. The at least two overhead wires extend over a predetermined distance and are supported by a mounting arrangement at a predetermined level above ground.

In yet another form, a method is provided. The method includes obtaining, by at least two overhead wires, power from one or more power sources. The at least two overhead wires extend over a predetermined distance and are supported by a mounting arrangement at a predetermined level above ground. The method further includes electrically connecting each of one or more electric vehicles to the at least two overhead wires using a connection interface and distributing the power bidirectionally between the one or more electric vehicles via the at least two overhead wires.

### EXAMPLE EMBODIMENTS

As electric vehicles (EVs) are gaining popularity, the number of charging stations are also increasing. Remodeling existing parking spaces to include the charging stations may be costly and time consuming. Nowadays, a charging station is installed for a parking space to charge a battery of the EV parked in this parking space. Typically, a charging station is added for each parking space where electric charging is to be available.

The techniques presented herein provide an overhead charging arrangement in which the EVs are charged in multiple parking spaces using overhead wires. Instead of installing individual charging stations for each vehicle parking space, the techniques presented herein provide overhead wires that span multiple vehicle parking spaces and provide power for charging the EVs parked in these parking spaces. The overhead wires span over multiple vehicle parking spaces such as commercial parking lots, parking garages, multi-family dwelling parking facilities, etc. The overhead wires are installed instead of the individual charging stations and distribute power for charging batteries of the EVs that connect to these overhead wires. As such, remodeling of the existing vehicle parking spaces is efficient and less costly.

Conventionally, power wires are high above ground for safety reasons (e.g., outside of human reach). In one or more example embodiments, the overhead wires distribute fault managed power (FMP). The FMP is safe power. As such, the overhead wires may be placed within a human reach e.g., approximately 6-11 feet above the ground and preferably around seven or eight feet so not to interfere with human and vehicle traffic. The overhead wires may account for vehicle and human traffic but are not restricted in height as the conventional high power wires.

The term “Fault Managed Power” (FMP) (also referred to as Extended Safe Power (ESP)) as used herein refers to power operation delivered on one or more wires or wire pairs. FMP may use pulse power or other types of power. That is, FMP may be accomplished in a non-pulsing manner. FMP may involve fault sensing with or without the use of pulse power. As described below, power and data may be transmitted together (in-band) on at least one wire pair. FMP also includes fault detection (e.g., fault detection (safety testing) at initialization and between high voltage pulses), and pulse synchronization between power sourcing equipment (PSE) and a powered device (PD). The power may be transmitted with communications (e.g., bi-directional communications) or without communications.

The term “pulse power” (also referred to as “pulsed power”) as used herein refers to power that is delivered in a sequence of pulses (alternating low direct current voltage state and high direct current voltage state) in which the voltage varies between a very small voltage (e.g., close to 0V, 3V) during a pulse-off interval and a larger voltage (e.g., >12V, >24V) during a pulse-on interval. High voltage pulse power (e.g., >56 VDC, >60 VDC, >300 VDC, ˜108 VDC, ˜380 VDC) may be transmitted from power sourcing equipment to a powered device for use in powering the powered device. Pulse power transmission may be through cables, transmission lines, bus bars, backplanes, PCBs (Printed Circuit Boards), and power distribution systems, for example. It is to be understood that the power and voltage levels described herein are only examples and other levels may be used. In another example embodiment of FMP, the voltage stays constant and the current is pulsed to a lower state at regular intervals. This allows for a constant voltage from the transmitting source(s), and can be a more efficient implementation.

As noted above, safety testing (fault sensing) may be performed through a low voltage safety check between high voltage pulses in the pulse power system, or a low current safety check between the higher current pulses in the pulse power system. Fault sensing may include, for example, line-to-line fault detection with low voltage sensing of the cable or components and line-to-ground fault detection with midpoint grounding. The time between high voltage pulses or high current pulses may be used, for example, for line-to-line resistance testing for faults and the pulse width may be proportional to DC (Direct Current) line-to-line voltage to provide touch-safe fault protection. The testing (fault detection, fault protection, fault sensing, touch-safe protection) may comprise auto-negotiation between power components. The high voltage DC pulse power may be used with a pulse-to-pulse decision for touch-safe line-to-line fault interrogation between pulses for personal safety.

In one or more example embodiments, FMP (FMP/ESP) may comprise pulse power transmitted in multiple phases in a multi-phase pulse power system with pulses offset from one another between wires or wire pairs to provide continuous power. One or more example embodiments may use multi-phase pulse power to achieve less loss with continuous uninterrupted power using overlapping phase pulses.

FMP may be converted into Power over Ethernet (POE) and used to power electrical components. In one or more example embodiments, power may be supplied using Single Pair Ethernet (SPE) and may include data communications (e.g., 1-10 GE (Gigabit Ethernet)). The power system may be configured for PoE (e.g., conventional PoE or PoE+ at a power level <100 watts (W), at a voltage level <57 volts (V), according to IEEE 802.3af, IEEE 802.3at, or IEEE 802.3bt), Power over Fiber (PoF), advanced power over data, FMP, or any other power over communications system in accordance with current or future standards, which may be used to pass electrical power along with data to allow a single cable to provide both data connectivity and electrical power to components (e.g., battery charging components, server data components, electric vehicle components).

In one or more example embodiments, the overhead wires may use one or more power sources such as an alternating current (AC) power source, a direct current (DC) power source, a renewable energy power source, and/or a fault managed power (FMP) source. For example, the power sources may include utility power, battery power, and solar power. The power may then be converted into FMP and distributed by the overhead wires to one or more EVs, by way of an example. The EVs use this power to charge their batteries and/or for powering one or more components within the vehicle. The EVs may further use the overhead wires for data communications e.g., high speed data communications.

In one or more example embodiments, the overhead wires may distribute power among other devices such as network devices, user equipment, and/or power sources. For example, a large battery or a solar system may be interconnected to the overhead wires for power distribution. As another example, power distribution may be provided by the overhead wires to a digital building and/or street cameras, lights, etc. The techniques presented herein are not limited to EV charging and may involve other devices. The overhead wires provide bidirectional FMP distribution and may deploy a multi-drop FMP configuration or a point to point FMP configuration.

In one or more example embodiment, a connector configured to connect a device such as an EV to the overhead wires is provided. The connector converts the FMP obtained from the overhead wires into the AC power or direct current (DC) power for charging a battery in the EV, for example. The connector may include an adapter or a J1772 adapter that converts FMP to a power type compatible with a respective EV, a network device, user equipment, or another device. The connector may be wires attached to the overhead wires and extending downwards away from the overhead wires for plugging into a respective device. The connector may be a retractable pole that is mounted or integrally formed with the device such as the EV and extends vertically towards the overhead wires for connection.

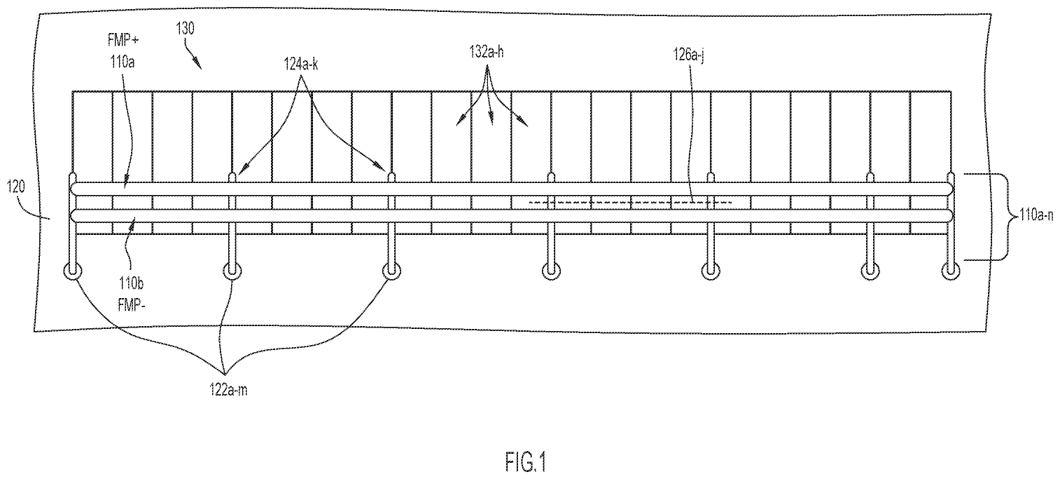

FIG. 1 is a view illustrating a system 100 with overhead wires for power distribution, which span over multiple vehicle parking spaces, according to an example embodiment. The system 100 includes overhead wires 110a-n and a mounting arrangement 120 in a parking lot space 130.

The notations 1, 2, 3, . . . n; a, b, c, . . . n; “a-n”, “a-d”, “a-f”, “a-g”, “a-k”, “a-c”, and the like illustrate that the number of elements can vary depending on a particular implementation and is not limited to the number of elements being depicted or described. Moreover, this is only examples of various components, and the number and types of components, functions, etc. may vary based on a particular deployment and use case scenario.

The overhead wires 110a-n may include a single wire pair or a multi-wire pair such as a first FMP wire 110a (FMP+) and a second FMP wire 110b (FMP−). The overhead wires 110a-n may be in one or more cables. The overhead wires 110a-n extend over a predetermined distance and at a predetermined level above the ground. Since the overhead wires 110a-n distribute FMP, the overhead wires 110a-n may be positioned within a human reach and below ten feet above the ground e.g., more than seven and less than eleven feet.

The number of overhead wires 110a-n and the actual distance above the ground (height) depends on a particular deployment and use case scenario. For example, in a parking garage, the overhead wires 110a-n may be mounted on a ceiling of the garage floors e.g., about eight or nine feet above ground. As another example, the overhead wires 110a-n may be mounted above the ground in a parking lot using the mounting arrangement 120. In this case, the overhead wires 110a-n may be only seven feet above the ground just high enough to meet the human and vehicle traffic below them. Flexibility exists with respect to the height of mounting the overhead wires 110a-n and may depend on a particular deployment and use case scenario e.g., the overhead wires 110a-n may be less than eleven feet above the ground. In one or more example embodiments, the overhead wires 110a-n distribute FMP, which is safe power.

In one or more example embodiments, the multi-drop configuration of the overhead wires 110a-n may be 11 KW for an entire row of parking spaces, where each electric vehicle, once allowed, obtains at least 1200 Watts and up to 11 KW. It should be noted that more power may be delivered, and that multiple bi-directional multi-drops (connection interfaces extending downwards) may be used to double or triple the 11 KW. The amount of power being distributed by the overhead wires 110a-n depends on a particular deployment and use case scenario.

The mounting arrangement 120 supports the overhead wires 110a-n at the predetermined level above ground such as seven to eleven feet above the ground. The mounting arrangement 120 includes a plurality of vertical poles 122a-m configured to extend the overhead wires 110a-n above ground at the predetermined height. The plurality of vertical poles 122a-m may be poles already present in the parking lot space 130 such as light poles or other poles already installed in the parking lot space 130.

The mounting arrangement 120 further includes a plurality of horizontal brackets 124a-k that may be attached to or integrally formed with the plurality of vertical poles 122a-m. The horizontal brackets 124a-k are installed to serve as horizontal wire holders. The horizontal brackets 124a-k hold the overhead wires 110a-n. The horizontal brackets 124a-k provide support for the overhead wires 110a-n and may reduce their sagging or dipping.

The mounting arrangement 120 may further include guide wires 126a-j. The guide wires 126a-j are configured to hold the overhead wires 110a-n in place and guide the overhead wires 110a-n to the next horizontal bracket. For example, the guide wires 126a-j may help maintain the overhead wires 110a-n in place (constant) despite environmental elements such as wind, snow, etc. The guide wires 126a-j may prevent horizontal shifts of the overhead wires 110a-n and help avoid unwanted disconnects from the connectors of the EVs or other devices.

The overhead wires 110a-n span over vehicle parking spaces 132a-h in the parking lot space 130. Any EV parked in the vehicle parking spaces 132a-h may use the overhead wires 110a-n to charge their battery and/or power other components of the EV. Additionally, the overhead wires 110a-n may draw power from a battery of a first EV and provided this power to charge a battery of a second EV. Instead of individual charging stations per vehicle parking space, the overhead wires 110a-n provide a low cost solution to charge multiple EVs in a multi-drop configuration. The overhead wires 110a-n may also distribute power to other devices e.g., a battery on a curb, a camera on a vertical pole of the mounting arrangement, etc.

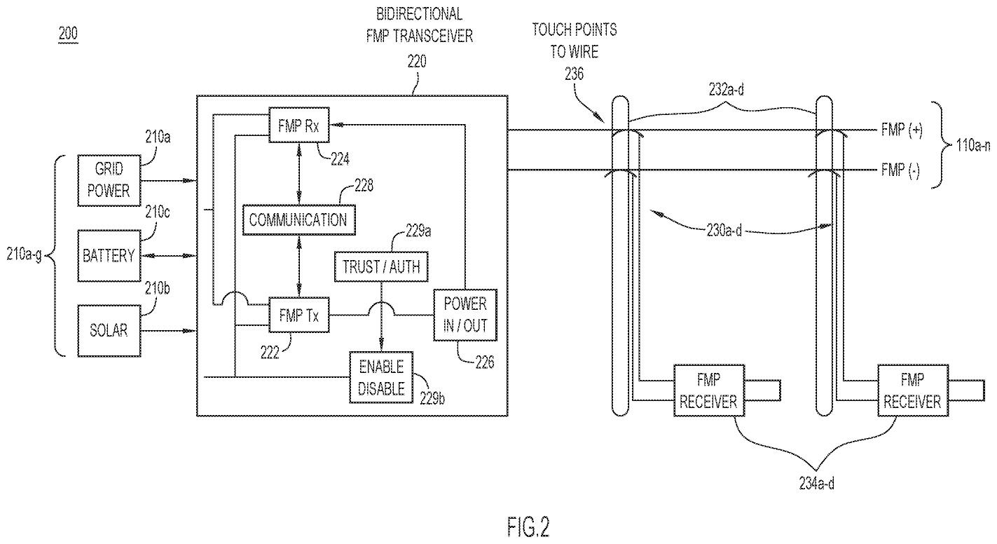

With continued reference to FIG. 1, FIG. 2 is a diagram illustrating a system 200 configured to provide fault managed power (FMP) to overhead wires 110a-n of FIG. 1, according to an example embodiment. The system 200 includes the overhead wires 110a-n of FIG. 1, power sources 210a-g, a bidirectional FMP transceiver 220, and connection interfaces 230a-d.

In one or more example embodiments, the power sources 210a-g include utility power such as grid power 210a, renewable energy power such as solar 210b, and a battery 210c. Power is supplied from the power sources 210a-g to the bidirectional FMP transceiver 220. The power may be utility Alternating Current (AC) power, Direct Current (DC) power, FMP, and/or power from an alternative energy source such as a solar power system and/or a wind power system (e.g., 380 VDC or other voltage).

The bidirectional FMP transceiver 220 obtains power (and optionally data) from power sources 210a-g (and may combine received power to generate total available power for distribution using the overhead wires 110a-n). The bidirectional FMP transceiver 220 converts the received power to Fault Managed Power (FMP) and provides the FMP to the overhead wires 110a-n. Similarly, the bidirectional FMP transceiver 220 may receive FMP from the overhead wires 110a-n and provide it to one or more of the power sources 210a-g e.g., to charge the battery 210c.

The bidirectional FMP transceiver 220 includes an FMP transmitter (FMP TX 222), an FMP receiver (FMP RX 224), a power and data interface (in/out 226), a communications component (communication 228), a trust and authentication component 229a, and a switch (enable/disable 229b).

The bidirectional FMP transceiver 220 receives and transmits power and data. Power is supplied from the power sources 210a-g and is transmitted to the overhead wires 110a-n. FMP power received is received at the FMP receiver (FMP RX 224) and delivered to the FMP TX 222. If the in/out 226 receives power other than the FMP, the power may then be converted to the FMP and provided to the FMP TX 222 for distribution over the overhead wires 110a-n. Power may also be supplied to the bidirectional FMP transceiver 220 from the overhead wires 110a-n, which then provides the power (which may optionally be converted) to the in/out 226 for transmittal to the power sources 210a-g.

The communication 228 is configured to manage data. Internet or other network data is received and transmitted by the communication 228. The data may be provided to the FMP transmitter (FMP TX 222) for transmittal to connected EVs and/or network device(s) at the power and data interface (in/out 226).

The power and data interface (in/out 226) is an example of a bi-directional power connector that supplies power to the overhead wires 110a-n and/or power sources 210a-g. Data may also be received from the FMP receiver (FMP RX 224) for upload to a network via a communication infrastructure and/or for storage at an external service (in a cloud) via network device(s). The communication 228 is in communication with the trust and authentication component 229a for performing authentication functions.

The trust and authentication component 229a performs a trust anchor method to authenticate FMP and FMP-based communications. The trust and authentication component 229a allows for a secure trust layer to ensure communications, the FMP, and the charging, are all trusted and secure. The trust and authentication component 229a is in communication with a switching component (the enable/disable 229b), which may shut down power and data in the bidirectional FMP transceiver 220 if authentication fails and enable power and data if authentication succeeds.

The connection interfaces 230a-d are configured to contact the overhead wires 110a-n for electric connections. For example, the connection interfaces 230a-d connect respective electric vehicles to charge a battery therein or to obtain power from the battery and provide the power to charge another battery of another electric vehicle via the overhead wires 110a-n. Each connection interface contacts the overhead wires 110a-n at a touch point 236. The overhead wires 110a-n provide multiple drops per line i.e., the connection interfaces 230a-d for various vehicle parking spots. The connection interfaces 230a-d include connectors 232a-d and electric charging interfaces 234a-d.

The connectors 232a-d may be drop down wires that are attached to the overhead wires 110a-n and extend downwards away from the overhead wires 110a-n and toward the vehicle parking spaces. The drop down wires may be in a form of a cable or a hose that has the electric charging interfaces 234a-d at an end thereof to connect to the electric vehicles. The connectors 232a-d may be vertical poles that are mounted on a window or trunk/frunk of respective electric vehicles or that are built into the electric vehicles. The vertical poles are configured to contact the overhead wires 110a-n for electric connections e.g., extend away from the electric vehicle and towards the overhead wires 110a-n. The retractable vertical poles may move vertically similar to power antennas i.e., downwards for storage and upwards for connection to the overhead wires 110a-n.

The electric charging interfaces 234a-d are attached to the connectors 232a-d. The electric charging interfaces 234a-d may also include FMP transceivers to receive and transmit FMP (i.e., similar to the bidirectional FMP transceiver 220). The electric charging interfaces 234a-d include charging connectors such as J plug or Combined Charging System (CCS) connector, which connect to the EVs to electrically charge one or more batteries within the EVs and/or to perform one or more communications with the EVs. The electric charging interfaces 234a-d may be of different types depending on a particular use case scenario and type of the device (EV, network device, battery, etc.). The electric charging interfaces 234a-d may include a charging adapter configured to convert the FMP to DC power or another power to charge or discharge the battery in the EV or storage entity placed in the parking spot. For example, the charging adapter may convert FMP to J1772 type power or other power. In one example embodiment, one of the electric charging interfaces 234a-d may be an FMP receiver box that converts received FMP to DC and includes a charging connectors that plugs into the EV.

With continued reference to FIGS. 1 and 2, FIG. 3 is a diagram illustrating a system 300 in which electric vehicles charge or discharge using connection interfaces that are connected to the overhead wires 110a-n of FIG. 1, according to an example embodiment. The system 300 includes electric vehicles 310a-p, a mounting arrangement 320, a connection interface 330, and the overhead wires 110a-n.

The mounting arrangement 320 includes a vertical pole 322, a horizontal holder 324, and guide wires 326. The vertical pole 322 holds the overhead wires 110a-n at a predetermined height above ground (e.g., seven to eleven feet) and the horizontal holder 324 supports the overhead wires 110a-n and may space out the overhead wires 110a-n at a distance from one another. The guide wires 326 guide the overhead wires 110a-n to the next horizontal holder. In one example embodiment, the horizontal holder 324 may be integrally formed with the vertical pole 322. In another example embodiment, the mounting arrangement 320 may be omitted e.g., when the overhead wires are installed on a ceiling of the parking garage. In this case, supporting beams of the ceiling may be used as the mounting arrangement 320. That overhead wires 110a-n are then mounted and hold in place from above i.e., the ceiling.

Electric vehicles 310a-p charge and discharge using the connection interface 330. The connection interface 330 forms an FMP connection between the overhead wires 110a-n and respective one of the electric vehicles 310a-p. The connection interface 330 may be drop down wires that are attached to the overhead wires 110a-n and extend downwards to a charging interface that plugs into the respective electric vehicle. The charging interface may include a charging adapter that converts FMP to DC power or other power for charging the battery of the respective electric vehicle.

In another example embodiment, the connection interface 330 may be a pole integrated into a respective electric vehicle (e.g., an antenna type pole), a retractable pole having a motorized mechanism that raises the retractable pole towards the overhead wires 110a-n or lowers the retractable pole away from the overhead wires 110a-n. In yet another example embodiment, the connection interface 330 may be a pole with wires that is side mounted onto the respective electric vehicle. These are just some non-limiting examples of the connection interface 330. The connection interface 330 include other mechanical arrangements that are configured to form an electric connection between the overhead wires 110a-n and the respective device.

With continued reference to FIGS. 1-3, FIG. 4 is a diagram illustrating a retractable connector 400 configured to connect to the overhead wires 110a-n of FIG. 1 using a motor mechanism, according to an example embodiment. The retractable connector 400 includes a window mount 402, a motor mechanism 404, a pole 406, a detection probe 408, a horizontal bar 410, and a controller 412. The retractable connector 400 is particularly useful for existing electric vehicles because it is removably mounted onto an EV without involving adjustments to the EV. That is, the retractable connector 400 may be an aftermarket component for the EV.

Specifically, the window mount 402 is configured to be mounted onto a side of a window, a trunk lip, or a frunk lip. The window mount 402 is just one example of a mounting arrangement for mounting the retractable connector 400 onto the electric vehicle. Other mounting arrangement may be utilized depending on a particular deployment and use case scenario. For example, a mounting arrangement may mount the retractable connector 400 onto the roof of the electric vehicle, inside the electric vehicle and extend the retractable connector 400 to the outside and away from the EV, etc.

The motor mechanism 404 is configured to automatically adjust the retractable connector 400 (vertically and optionally horizontally i.e., swivel) for maintaining contact with the overhead wires 110a-n. The motor mechanism 404 includes a first motor configured to control the height of the retractable connector 400 (raising towards and lowering away from the overhead wires 110a-n). The first motor controls the vertical movement of the pole 406. The pole 406 is raised to contact the overhead wires 110a-n and is lowered away or retracted for storage. The motor mechanism 404 further includes a second motor configured to swivel the pole 406. By swiveling the pole 406, the horizontal bar 410 moves into contact with the overhead wires 110a-n and maintains contact with the overhead wires despite environmental factors e.g., wind, vibrations, etc. that may slightly move the overhead wires 110a-n.

The detection probe 408 (a detector or sensor) is configured to detect the location of the overhead wires 110a-n. The location of the overhead wires detected by the detector is provided to the controller 412. The controller 412 instructs the motor mechanism 404 to adjust the height of the pole 406 and/or to swivel the pole 406. The detection probe 408 may be a basic voltage probe detector for PoE/FMP voltage to align the pole 406 to the overhead wires 110a-n. The pole 406 is adjusted until PoE/FMP is detected by the detector, then the pole 406 is raised and/or aligned using the motor mechanism 404. In one example embodiment, a manual system may be used for positioning the pole 406 until FMP is negotiated and applied. For safety, when the electric vehicle is already charging, it might be preferable to shut down FMP to PoE until a second power system is connected and then power up after negotiation. Additionally, using the detection probe 408, the pole 406 is configured to automatically track and maintain FMP connection (contact) should the overhead wires 110a-n move e.g., due to wind.

The retractable connector 400 further includes a charging connector (not shown) that plug into the electric vehicle to charge a battery therein or to obtain the power from the battery of the electric vehicle and provide the power to the overhead wires to charge another battery of another electric vehicle.

In one example embodiment, the retractable connector 400 may be integrally formed in the electric vehicle e.g., similar to a powered antenna. In this case, the mounting arrangement (the window mount 402) may be omitted.

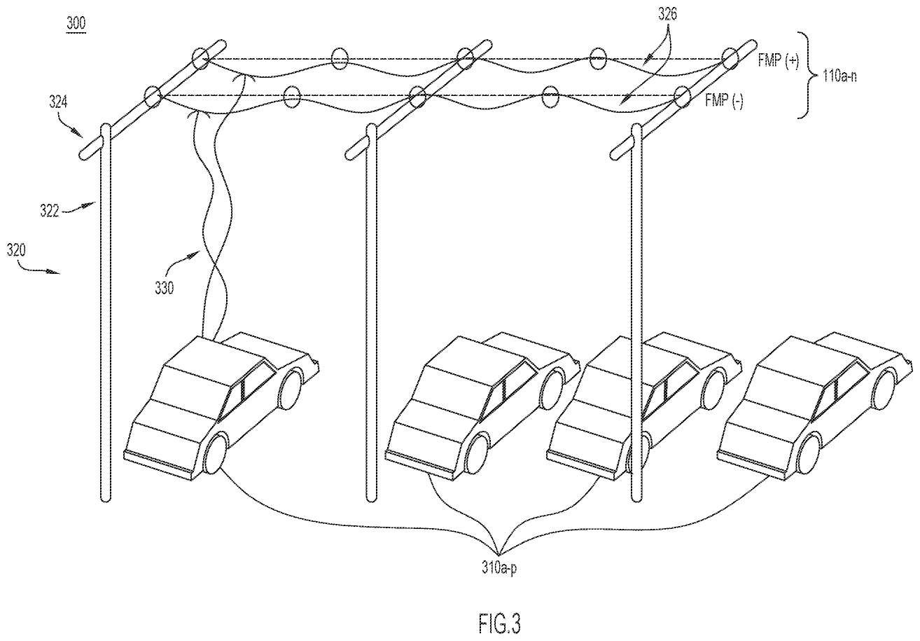

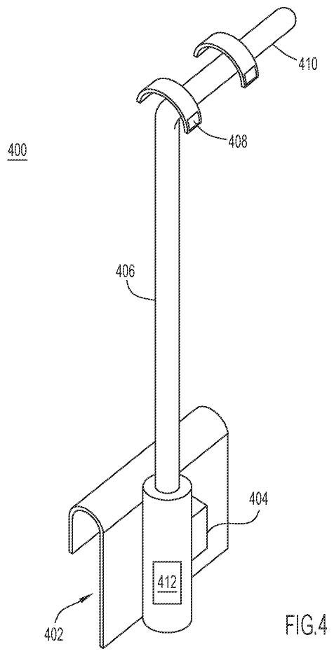

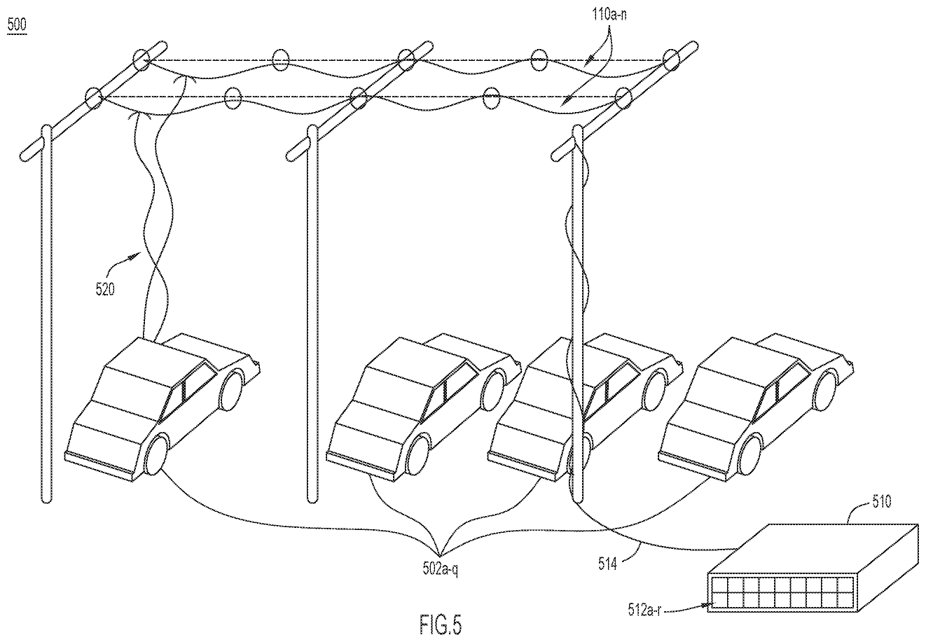

With continued reference to FIGS. 1-4, FIG. 5 is a diagram illustrating a system 500 in which network communications are enabled for an electric vehicle using the overhead wires, according to an example embodiment. The system 500 provides network communications for electric vehicles connected to the overhead wires without high speed physical connections. The system 500 includes electric vehicles 502a-q, a network device 510, the overhead wires 110a-n of FIG. 1, and a connection interface 520. The connection interface 520 may be one of the connection interfaces 230a-d of FIG. 2, the connection interface 330 of FIG. 3, or the retractable connector 400 of FIG. 4.

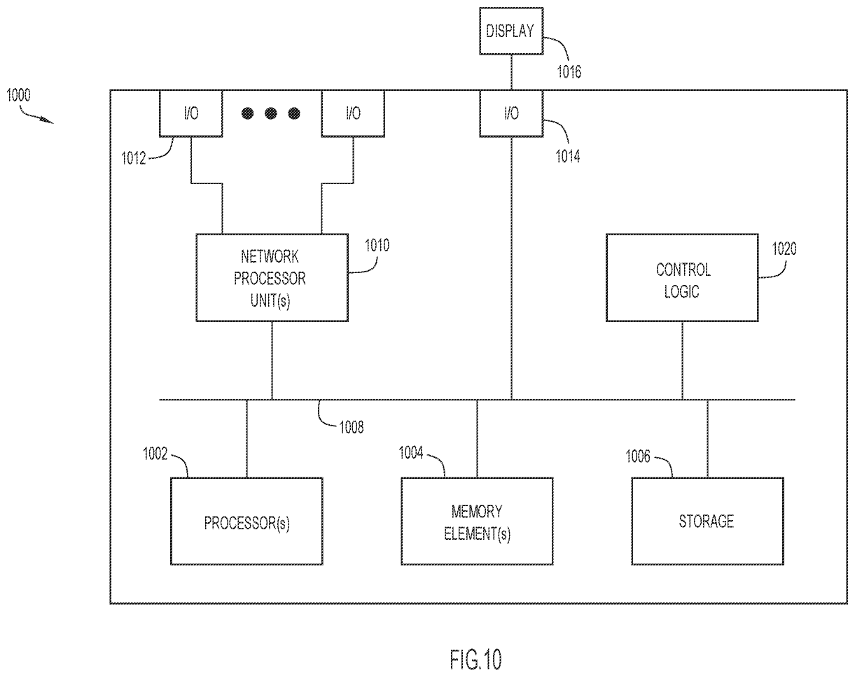

The network device 510 may be a switch or router that resides inside or outside premises e.g., on a curb of the vehicle parking space or next to one or more power sources. The network device 510 enable network or data communications e.g., high speed data communication. The network device 510 includes a network interface (e.g., network processing unit (NPU)), a processor, and a memory. In one example embodiment, the network device 510 may include one or more components described in FIG. 10.

The network device 510 may be powered by AC power, DC power, and/or FMP. The network device 510, enabled for network communications, may have a data up link of 400 GE or more. The network device 510 may include single pair ethernet (SPE) and/or FMP using 1 GE i.e., ports 512a-r. The network device 510 may also be connected to the overhead wires 110a-n using a single pair Ethernet plus FMP on the same pair of wires 514.

In one example embodiment, if an electric vehicle is designed for high speed communication through the power connection e.g., J1772 or CCS1, then the high speed data communication may then occur via the overhead wires 110a-n and the pair of wires 514. That is, the electric vehicles 502a-q connect to the overhead wires 110a-n via the connection interface 520 and are enabled to perform high speed data communications via the overhead wires 110a-n and the pair of wires 514 i.e., using the network device 510. However, some electric vehicles may not be configured to include high speed physical data connections.

With continued reference to FIGS. 1-5, FIG. 6 is a diagram illustrating a multi-drop system 600 in which network communications are enabled for an electric vehicle using a connection interface, according to an example embodiment. The multi-drop system 600 includes the overhead wires 110a-n, connection interfaces 610a-s, a communication enabled connection interface 620, and an electric vehicle 630. The multi-drop system 600 has multiple drops per line using the connection interfaces 610a-s and the communication enabled connection interface 620.

The connection interfaces 610a-s are similar to the connection interfaces 230a-d in FIG. 2. The connection interfaces 610a-s contact the overhead wires 110a-n at various connection or touch points, e.g., at a touch point 602. The connection interfaces 610a-s may convert FMP from the overhead wires 110a-n to another power for the respective device (e.g., at 2 KW increments). The other power may be DC power, AC power, etc. The respective device may be the electric vehicle 630 but is not limited thereto and may be a power source such as a battery or another device. The connection interfaces 610a-s connect to the device using a charging interface 604 specific for the device. For electric vehicles, J type or CCS charging connector type may be used.

In one example embodiment, a connection interface may enable data communications for the electric vehicle 630. For example, the communication enabled connection interface 620 includes additional components to enable data communications. The communication enabled connection interface 620 contacts the overhead wires 110a-n for power and data communications e.g., FMP data and power at a connection point 622. The communication enabled connection interface 620 includes an FMP RX 624 (and may include FMP TX and a power converter/adapter), a charging connector 626 (a hose) to plug into the electric vehicle 630, at 628. The communication enabled connection interface 620 may further include a data interface 632 (in/out), an authentication module 634 or trust and authentication module (TAM), and a short range communication module 636 (Wi-Fi or Bluetooth).

The power and data are received from the overhead wires 110a-n at the FMP RX 624. The FMP may then be converted and power provided to the charging connector 626 to charge a battery of the electric vehicle 630. The data interface 632 receives data from the FMP receiver (FMP RX 624) for upload to a network via a communication infrastructure and/or for storage at an external service via network device(s). In one example embodiment, the data interface 632 enables network communications outside of the connection interface 620 i.e., the NPU. In one example embodiment, the data interface 632 includes connection to internet and/or other network(s). In yet another example embodiment, the data interface 632 includes a cellular module, wired, fiber optics, e.g., a router. The data interface 632 transmits and receives data from an external entity (e.g., the electric vehicle 630, cloud management entity, etc.). In yet another example embodiment, the data interface 632 is configured to receive data from the electric vehicle 630 and to provide the data via the overhead wires 110a-n to a network device for transmission to an external entity. The data interface 632 is in communication with the trust and authentication component i.e., the authentication module 634 for performing authentication functions.

The authentication module 634 performs authentication functions for connecting to the electric vehicle 630. The authentication module 634 performs access control for the electric vehicle 630 that is using the connection interface 620. Further, the authentication module 634 performs access control before any data transfers are permitted. For example, the authentication module 634 may instruct the connection interface 620 to shut down power and data if authentication fails. The authentication module 634 may shut down power to the FMP RX 624 if authentication fails. The authentication module 634 may shut down communication between the electric vehicle 630 and a network device based on a failed authentication. In other words, the authentication module 634 authenticates the electric vehicle 630 with respect to the fault managed power and FMP based communications, thereby allowing for a secure trust layer to ensure that the communications and charging power are all trusted. The authentication module 634 may further verify proper FMP transmitter to FMP receiver interfaces and connections, to allow only trusted devices to transmit or receive FMP. The authentication module 634 may be used to prevent destruction of the network devices or other EVs deployed at public locations (parking lot or parking garage) by controlling access to communications and use.

The short range communication module 636 enables one or more short range network communications such as Wi-Fi and/or Bluetooth access for communication with the electric vehicle 630.

The electric vehicle 630 includes a car system 640 which includes a controller 642 configured to control components of the electric vehicle 630. The components may include a battery 644, a charging socket 646, and a short-range communication interface 648. The charging socket 646 communicates with other components (including the controller 642) using low speed charge protocol communications. The battery 644 powers the components of the car system 640. The short-range communication interface 648 communicates with the short range communication module 636 of the connection interface 620. Data from the electric vehicle may be provided to the connection interface 620 using the short range communication module 636. The connection interface 620 may then transmit data to an external entity using the data interface 632.

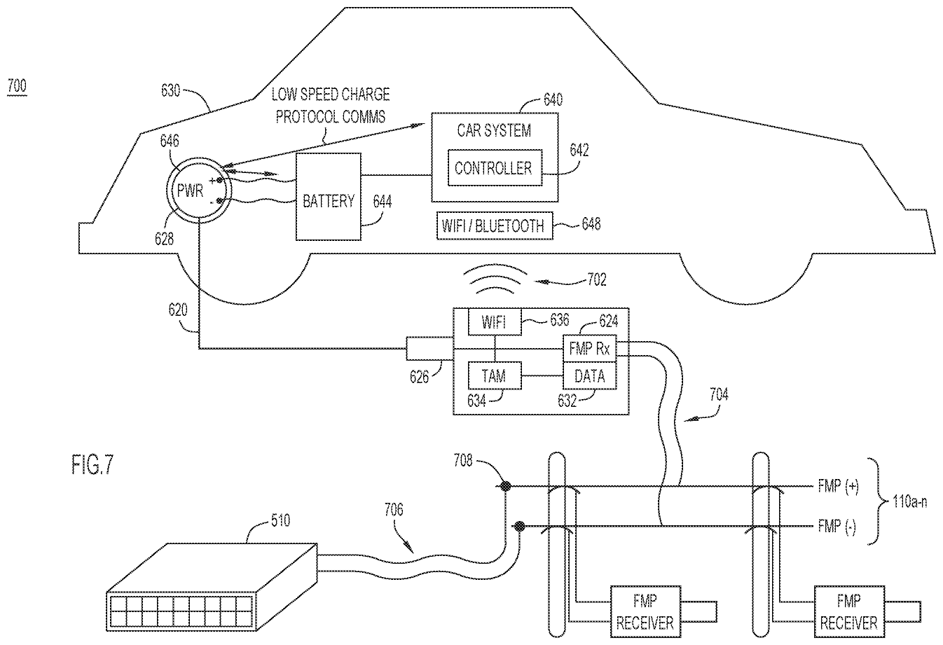

The car system 640 typically includes a firewall and other security and trust methods. The short-range communication interface 648 provides an extra layer of security for data transfers. The car system 640 may be configured to authenticate with the connection interface 620 prior to transferring data. The electric vehicle 630 not be enabled for high speed data communication is able to perform high speed data communication using the connection interface 620, as described in FIG. 7.

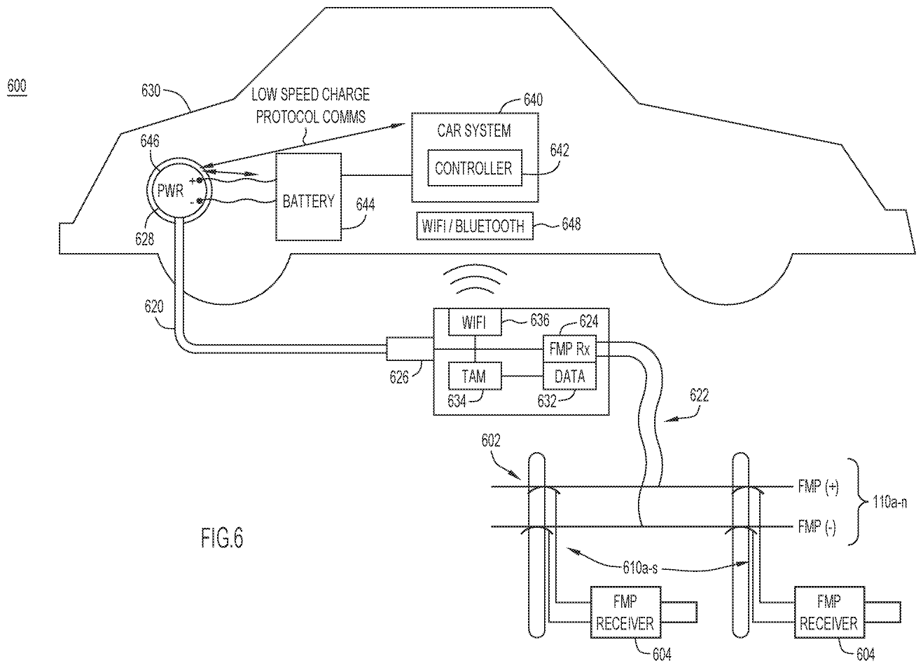

With continued reference to FIG. 6, FIG. 7 is a flow diagram illustrating the electric vehicle 630 of FIG. 6 establishing a communication path 700 with a network device, according to an example embodiment. The communication path 700 includes a short range communication path 702, an FMP communication path 704, and a data communication path 706.

In one example embodiment, when the electric vehicle 630 is connected to the connection interface 620 of FIG. 6, the authentication module 634 authenticates the electric vehicle 630 and establishes the short range communication path 702 between the short range communication module 636 and the short-range communication interface 648. The short range communication path 702 is a secure communication path. That is, layer of security is added for data transfers to and from the electric vehicle 630. The data may be encrypted and transmitted at 100 Mbit or 1 GE Ethernet. While Wi-Fi type communication path is shown, the short range communication path 702 may be secure Bluetooth communication path (secure pairing between the connection interface 620 and the electric vehicle 630).

When the connection interface 620 receives data from the short-range communication interface 648 of the electric vehicle 630, the connection interface 620 provides the data to the data interface 632 to be transmitted over the overhead wires 110a-n as FMP data. Data is transmitted over the FMP communication path 704 from the connection interface 620 via the overhead wires 110a-n. The FMP communication path 704 is also a secure communication path that transmits encrypted data. The data is then provided from the overhead wires 110a-n to the network device 510 via data communication path 706. A connection interface of the network device 510 contacts the overhead wires 110a-n at a touch point 708 and transmits the data to the network device 510. The network device 510 may then transmit the data to an external entity such as cloud database or a management service.

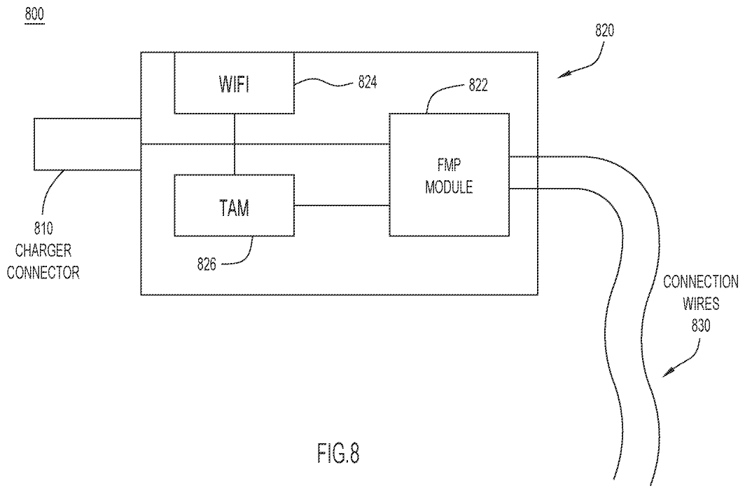

FIG. 8 is a block diagram illustrating a connection interface 800 in which high speed data communication is enabled, according to another example embodiment. The connection interface 800 includes a charging connector 810, an adapter box 820, and connection wires 830.

The charging connector 810 is configured to connect or plug into an EV (not shown) to charge a battery therein or power other components. The charging connector 810 may plug into the EV to draw power from the battery to power other devices e.g., another battery of another EV.

The adapter box 820 includes an FMP module 822, a short range communication module 824, and an authentication module 826. The FMP module 822 may include one or more components of the bidirectional FMP transceiver 220 of FIG. 2. The FMP module 822 may include an FMP RX and FMP TX, a communications component, and a power conversion component. The FMP module 822 is configured to receive and transmit FMP data and power between the EV (or connected device) and the overhead wires (not shown). The FMP module may convert FMP power to another power type (e.g., DC or AC). The short range communication module 824 may enable Bluetooth communications or Wi-Fi communications with the EV. The authentication module 826 is configured to authenticate the EV connected to the connection interface 800 and to authenticate high speed communications. If the authentication fails, the short range communication module 824 is disabled i.e., short range communication with the EV is disabled.

The connection wires 830 may be SPE and FMP type wires configured to contact the overhead wires. The connection wires 830 transmit data and power between the overhead wires and the adapter box 820. The connection wires 830 enable high speed communications.

The connection interface 800 provides a secure high speed data communication with the EV and converts the power and data into FMP power and data for distribution via the overhead wires. The EV obtains and/or provides data to a cloud (storage database) via the connection interface 800 that enables high speed and secure data communications.

The techniques presented herein allow for a low cost way to add EV charging using overhead wires. While a trench for providing power may still be used, the trench is only for power delivery to a first pole supporting the overhead wires. The overhead wires are safe and do not require significant height (e.g., not level 2 power). Pole height is made to account for vehicle/human traffic beneath the overhead wires. The techniques presented herein are easily deployed in a car parking lot and/or a car garage. The techniques presented herein may include overhead wires without a mounting arrangement i.e., a parking garage that is already wired for power. The techniques presented herein provide an FMP power delivery method using the overhead wires for EVs, large batteries, solar systems, and other devices. The EVs are interconnected through the overhead FMP distribution wires for charging and power distribution. The overhead wires may further transport data to and from the EVs. The techniques presented herein provide energy management solutions for parking places and other areas.

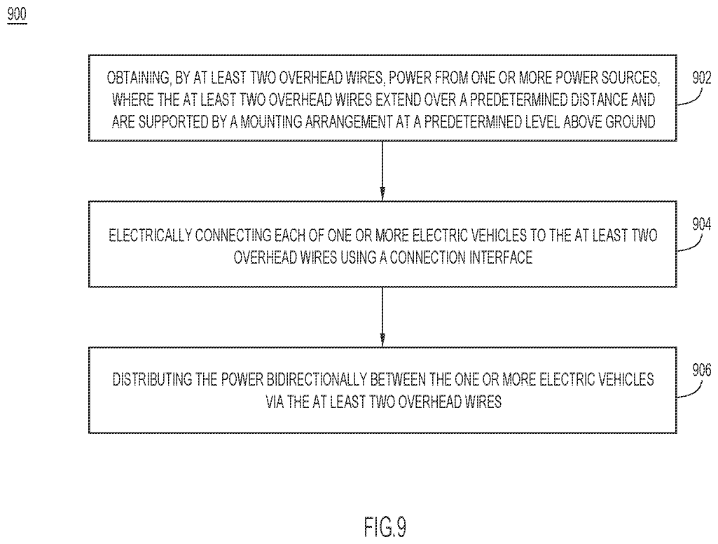

FIG. 9 is a flowchart illustrating a method 900 of bidirectionally distributing power among one or more electric vehicles via at least two overhead wires, according to an example embodiment.

The method 900 involves, at 902, obtaining, by at least two overhead wires, power from one or more power sources, wherein the at least two overhead wires extend over a predetermined distance and are supported by a mounting arrangement at a predetermined level above ground.

The method 900 further involves, at 904, electrically connecting each of one or more electric vehicles to the at least two overhead wires using a connection interface and, at 906, distributing the power bidirectionally between the one or more electric vehicles via the at least two overhead wires.

In one form, the operation 904 of electrically connecting each of the one or more electric vehicles to the at least two overhead wires may involve extending the connection interface for each of the one or more electric vehicles to contact the at least two overhead wires that are supported by the mounting arrangement at least seven feet and less than eleven feet above the ground and which span over a plurality of vehicle parking spaces.

In another form, the one or more electric vehicles may include a plurality of electric vehicles. The operation 906 of distributing the power bidirectionally may involve obtaining the power from the at least two overhead wires by each of the plurality of electric vehicles to charge a battery of a respective electric vehicle.

According to one or more example embodiments, the operation 906 of distributing the power bidirectionally may involve bidirectionally distributing fault managed power in a multi-drop arrangement to the one or more electric vehicles in the plurality of vehicle parking spaces using the at least two overhead wires.

In one instance, the operation 904 of electrically connecting each of the one or more electric vehicles to the at least two overhead wires may involve forming an electrical connection with the at least two overhead wires by contacting using the connection interface the at least two overhead wires at a touch point. The method 900 may further involve electrically charging the battery of the respective electric vehicle using an electric charging interface attached to the connector and plugged into the electric vehicle.

In another instance, the method 900 may further involve converting fault managed power distributed by the at least two overhead wires to a direct current (DC) power to charge the battery of the respective electric vehicle.

According to one or more example embodiments, the method 900 may further involve extending the connection interface to contact the at least two overhead wires.

In one form, the method 900 may further involve connecting the respective electric vehicle to the overhead wires using the connection interface and providing the power from the battery of the respective vehicle to another battery of another electric vehicle via the at least two overhead wires.

In another form, the method 900 may further involve providing high speed communication between the respective electric vehicle and at least one network device via the at least two overhead wires.

According to one or more example embodiments, the method 900 may further involve authenticating the respective electric vehicle for secure high speed communication with the at least one network device via the at least two overhead wires.

FIG. 10 is a hardware block diagram of a computing device 1000 that may perform functions associated with any combination of operations in connection with the techniques depicted in FIGS. 1-9, according to various example embodiments, including, but not limited to, operations of a network device e.g., a computing device. It should be appreciated that FIG. 10 provides only an illustration of one embodiment and does not imply any limitations with regard to the environments in which different embodiments may be implemented. Many modifications to the depicted environment may be made.

In at least one embodiment, computing device 1000 may include one or more processor(s) 1002, one or more memory element(s) 1004, storage 1006, a bus 1008, one or more network processor unit(s) 1010 interconnected with one or more network input/output (I/O) interface(s) 1012, one or more I/O interface(s) 1014, and control logic 1020. In various embodiments, instructions associated with logic for computing device 1000 can overlap in any manner and are not limited to the specific allocation of instructions and/or operations described herein.

In at least one embodiment, processor(s) 1002 is/are at least one hardware processor configured to execute various tasks, operations and/or functions for computing device 1000 as described herein according to software and/or instructions configured for computing device 1000. Processor(s) 1002 (e.g., a hardware processor) can execute any type of instructions associated with data to achieve the operations detailed herein. In one example, processor(s) 1002 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 1004 and/or storage 1006 is/are configured to store data, information, software, and/or instructions associated with computing device 1000, and/or logic configured for memory element(s) 1004 and/or storage 1006. For example, any logic described herein (e.g., control logic 1020) can, in various embodiments, be stored for computing device 1000 using any combination of memory element(s) 1004 and/or storage 1006. Note that in some embodiments, storage 1006 can be consolidated with one or more memory elements 1004 (or vice versa), or can overlap/exist in any other suitable manner.

In at least one embodiment, bus 1008 can be configured as an interface that enables one or more elements of computing device 1000 to communicate in order to exchange information and/or data. Bus 1008 can be implemented with any architecture designed for passing control, data and/or information between processors, memory elements/storage, peripheral devices, and/or any other hardware and/or software components that may be configured for computing device 1000. In at least one embodiment, bus 1008 may be implemented as a fast kernel-hosted interconnect, potentially using shared memory between processes (e.g., logic), which can enable efficient communication paths between the processes.

In various embodiments, network processor unit(s) 1010 may enable communication between computing device 1000 and other systems, entities, etc., via network I/O interface(s) 1012 to facilitate operations discussed for various embodiments described herein. In various embodiments, network processor unit(s) 1010 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 1000 and other systems, entities, etc. to facilitate operations for various embodiments described herein. In various embodiments, network I/O interface(s) 1012 can be configured as one or more Ethernet port(s), Fibre Channel ports, and/or any other I/O port(s) now known or hereafter developed. Thus, the network processor unit(s) 1010 and/or network I/O interface(s) 1012 may include suitable interfaces for receiving, transmitting, and/or otherwise communicating data and/or information in a network environment.

I/O interface(s) 1014 allow for input and output of data and/or information with other entities that may be connected to computing device 1000. For example, I/O interface(s) 1014 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor 1016, a display screen, or the like.

In various embodiments, control logic 1020 can include instructions that, when executed, cause processor(s) 1002 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes an electric charging interface configured to charge a battery of an electric vehicle when connected to the electric vehicle. The apparatus further includes a connector attached to the electric charging interface and configured to contact at least two overhead wires for a bidirectional power distribution with the battery of the electric vehicle. The at least two overhead wires extend over a predetermined distance and are supported by a mounting arrangement at a predetermined level above ground.

In one form, the apparatus may further include an electric charging adapter configured to convert fault managed power provided by the at least two overhead wires and a direct current (DC) power that charges the battery of the electric vehicle.

In another form, the apparatus may include a network communication interface configured to enable secure network communications between the electric vehicle and at least one network device connected to the at least two overhead wires.

According to one or more example embodiments, the connector may be an extendable pole mounted in the electric vehicle and configured to vertically extend to contact each of the at least two overhead wires. The at least two overhead wires may be supported by the mounting arrangement at least seven feet and less than eleven feet above the ground and may span over a plurality of vehicle parking spaces.

In one instance, the connector may be a retractable pole integrated into the electric vehicle. The connector may include at least one motor configured to move the retractable pole vertically towards the at least two overhead wires and away from the at least two overhead wires. The connector may further include at least one detector configured to detect a location of the at least two overhead wires and a controller configured to control the at least one motor to move the retractable pole such that contact is maintained with the at least two overhead wires based on the location detected by the at least one detector.

In yet another example embodiment, a system is provided. The system includes at least two overhead wires that extend over a predetermined distance and are configured to bidirectionally distribute power among one or more electric vehicles. The system further includes a mounting arrangement configured to support the at least two overhead wires at a predetermined level above ground. The system further includes one or more connection interfaces. Each connection interface is configured to contact the at least two overhead wires and connect to a respective electric vehicle to charge a battery therein or to obtain the power from the battery and provide the power to the at least two overhead wires to charge another battery of another electric vehicle.

In one form, the mounting arrangement may include a plurality of vertical poles configured to support the at least two overhead wires at least seven feet and less than eleven feet above the ground. The at least two overhead wires may span over a plurality of vehicle parking spaces.

In another form, the at least two overhead wires may be configured to bidirectionally distribute fault managed power in a multi-drop arrangement to the one or more electric vehicles in the plurality of vehicle parking spaces.

According to one or more example embodiments, each of the one or more connection interfaces may include a connector configured to contact the at least two overhead wires at a touch point for forming an electrical connection with the at least two overhead wires. Each of the one or more connection interfaces may further include an electric charging interface attached to the connector and configured to connect to the respective electric vehicle to charge the battery therein.

In one instance, the electric charging interface may include an electric charging adapter configured to convert fault managed power distributed by the at least two overhead wires to a direct current (DC) power to charge the battery of the respective electric vehicle.

In another instance, the connector may include a retractable pole mounted on the respective electric vehicle and configured to extend toward the at least two overhead wires and retract from the at least two overhead wires.

According to one or more example embodiments, the connector may further include a horizontal bar supported by the retractable pole and configured to contact each of the at least two overhead wires when the retractable pole is extended.

In yet another instance, the connector may include a connection wire attached to each of the at least two overhead wires and configured to extend downwards to connect the electric charging interface with the respective electric vehicle.

In one form, the connector may include a retractable pole installed in the respective electric vehicle and at least one motor configured to move the retractable pole vertically to and from the at least two overhead wires.

In one instance, the connector may further include a horizontal bar integrally formed with the retractable pole and configured to contact each of the at least two overhead wires. The connector may further include at least one detector configured to detect a location of the at least two overhead wires and a controller configured to control the at least one motor to retract the retractable pole such that the horizontal bar maintains contact with each of the at least two overhead wires based on the location detected by the at least one detector.

According to one or more example embodiments, each of the one or more connection interfaces may be configured to connect to the respective electric vehicle to obtain the power from the battery and to provide the power to the another battery of the another electric vehicle via the at least two overhead wires.

In one instance, each of the one or more connection interfaces may be configured to connect to the electric vehicle to obtain the power from the battery of the electric vehicle and to provide the power to one or more other devices via the at least two overhead wires.

In another instance, each of the one or more connection interfaces may include a communication interface configured to provide high speed communication between the respective electric vehicle and at least one network device via the at least two overhead wires.

According to one or more example embodiments, the at least one network device connected to the at least two overhead wires may be configured to enable network communications for a plurality of electric vehicles connected to the at least two overhead wires.

In yet another instance, each of the one or more connection interfaces may include a connector configured to contact the at least two overhead wires at a touch point for forming a power and data connection with the at least two overhead wires. Each of the one or more connection interfaces may further include an electric charging interface attached to the connector and configured to connect to the respective electric vehicle to charge the battery therein. Each of the one or more connection interfaces may further include at least one authentication component configured to authenticate the high speed communication via the at least two overhead wires between the respective electric vehicle and the at least one network device.

In yet another example embodiment, an apparatus may include a memory, a network interface configured to enable network communications, and a processor. The processor is configured to perform various operations described in FIGS. 1-10.

In yet another example embodiment, one or more non-transitory computer readable storage media encoded with instructions are provided. When the media is executed by a processor, the instructions cause the processor to execute various operations described in FIGS. 1-10.

In yet another example embodiment, a system is provided that includes the devices and operations explained above with reference to FIGS. 1-10.

The programs described herein (e.g., control logic 1020) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 1006 and/or memory elements(s) 1004 can store data, software, code, instructions (e.g., processor instructions), logic, parameters, combinations thereof, and/or the like used for operations described herein. This includes the storage 1006 and/or memory elements(s) 1004 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A system comprising:
at least two overhead wires that extend over a predetermined distance and are configured to bidirectionally distribute power among one or more electric vehicles;
a mounting arrangement configured to support the at least two overhead wires at a predetermined level above ground; and
one or more connection interfaces, each configured to contact the at least two overhead wires and connect to a respective electric vehicle to charge a battery therein or to obtain the power from the battery and provide the power to the at least two overhead wires to charge another battery of another electric vehicle.

2. The system of claim 1, wherein the mounting arrangement includes a plurality of vertical poles configured to support the at least two overhead wires at least seven feet and less than eleven feet above the ground and wherein the at least two overhead wires span over a plurality of vehicle parking spaces.

3. The system of claim 2, wherein the at least two overhead wires are configured to bidirectionally distribute fault managed power in a multi-drop arrangement to the one or more electric vehicles in the plurality of vehicle parking spaces.

4. The system of claim 1, wherein each of the one or more connection interfaces comprises:
a connector configured to contact the at least two overhead wires at a touch point for forming an electrical connection with the at least two overhead wires; and
an electric charging interface attached to the connector and configured to connect to the respective electric vehicle to charge the battery therein.

5. The system of claim 4, wherein the electric charging interface includes an electric charging adapter configured to convert fault managed power distributed by the at least two overhead wires to a direct current (DC) power to charge the battery of the respective electric vehicle.

6. The system of claim 4, wherein the connector includes a retractable pole mounted on the respective electric vehicle and configured to extend toward the at least two overhead wires and retract from the at least two overhead wires.

7. The system of claim 6, wherein the connector further includes a horizontal bar supported by the retractable pole and configured to contact each of the at least two overhead wires when the retractable pole is extended.

8. The system of claim 4, wherein the connector includes a connection wire attached to each of the at least two overhead wires and configured to extend downwards to connect the electric charging interface with the respective electric vehicle.

9. The system of claim 4, wherein the connector includes:
a retractable pole installed in the respective electric vehicle; and
at least one motor configured to move the retractable pole vertically to and from the at least two overhead wires.

10. The system of claim 9, wherein the connector further includes:
a horizontal bar integrally formed with the retractable pole and configured to contact each of the at least two overhead wires;
at least one detector configured to detect a location of the at least two overhead wires; and
a controller configured to control the at least one motor to retract the retractable pole such that the horizontal bar maintains contact with each of the at least two overhead wires based on the location detected by the at least one detector.

11. The system of claim 1, wherein each of the one or more connection interfaces is configured to connect to the respective electric vehicle to obtain the power from the battery and to provide the power to the another battery of the another electric vehicle via the at least two overhead wires.

12. The system of claim 1, wherein each of the one or more connection interfaces is configured to connect to the electric vehicle to obtain the power from the battery of the electric vehicle and to provide the power to one or more other devices via the at least two overhead wires.

13. The system of claim 1, wherein each of the one or more connection interfaces includes:
a communication interface configured to provide high speed communication between the respective electric vehicle and at least one network device via the at least two overhead wires.

14. The system of claim 13, wherein the at least one network device connected to the at least two overhead wires is configured to enable network communications for a plurality of electric vehicles connected to the at least two overhead wires.

15. The system of claim 13, wherein each of the one or more connection interfaces comprises:
a connector configured to contact the at least two overhead wires at a touch point for forming a power and data connection with the at least two overhead wires;
an electric charging interface attached to the connector and configured to connect to the respective electric vehicle to charge the battery therein; and
at least one authentication component configured to authenticate the high speed communication via the at least two overhead wires between the respective electric vehicle and the at least one network device.

16. An apparatus comprising:
an electric charging interface configured to charge a battery of an electric vehicle when connected to the electric vehicle; and
a connector attached to the electric charging interface and configured to contact at least two overhead wires for a bidirectional power distribution with the battery of the electric vehicle, wherein the at least two overhead wires extend over a predetermined distance and are supported by a mounting arrangement at a predetermined level above ground.

17. The apparatus of claim 16, further comprising:
an electric charging adapter configured to convert fault managed power provided by the at least two overhead wires and a direct current (DC) power that charges the battery of the electric vehicle.

18. The apparatus of claim 16, further comprising:
a network communication interface configured to enable secure network communications between the electric vehicle and at least one network device connected to the at least two overhead wires.

19. The apparatus of claim 16, wherein the connector is an extendable pole mounted in the electric vehicle and configured to vertically extend to contact each of the at least two overhead wires, which are supported by the mounting arrangement at least seven feet and less than eleven feet above the ground and which span over a plurality of vehicle parking spaces.

20. The apparatus of claim 16, wherein the connector is a retractable pole integrated into the electric vehicle and comprising:
at least one motor configured to move the retractable pole vertically towards the at least two overhead wires and away from the at least two overhead wires;
at least one detector configured to detect a location of the at least two overhead wires; and
a controller configured to control the at least one motor to move the retractable pole such that contact is maintained with the at least two overhead wires based on the location detected by the at least one detector.

21. A method comprising:
obtaining, by at least two overhead wires, power from one or more power sources, wherein the at least two overhead wires extend over a predetermined distance and are supported by a mounting arrangement at a predetermined level above ground;
electrically connecting each of one or more electric vehicles to the at least two overhead wires using a connection interface; and
distributing the power bidirectionally between the one or more electric vehicles via the at least two overhead wires.

22. The method of claim 21, wherein electrically connecting each of the one or more electric vehicles to the at least two overhead wires includes:
extending the connection interface for each of the one or more electric vehicles to contact the at least two overhead wires that are supported by the mounting arrangement at least seven feet and less than eleven feet above the ground and which span over a plurality of vehicle parking spaces.

23. The method of claim 21, wherein the one or more electric vehicles include a plurality of electric vehicles and distributing the power bidirectionally includes:
obtaining the power from the at least two overhead wires by each of the plurality of electric vehicles to charge a battery of a respective electric vehicle.
